(19) United States
(12) Patent Application Publication
(10) Pub. No.: US 2015/0199035 A1
(43) Pub. Date: Jul. 16, 2015

(54) STYLUS WITHOUT ACTIVE COMPONENTS AND AN ASSOCIATED TOUCH PANEL

(71) Applicant: HIMAX TECHNOLOGIES LIMITED, Tainan City (TW)

(72) Inventors: YAW-GUANG CHANG, Tainan City (TW); Guan-Ying Huang, Tainan City (TW)

(73) Assignee: HIMAX TECHNOLOGIES LIMITED, Tainan City (TW)

(21) Appl. No.: 14/198,558

(22) Filed: Mar. 5, 2014

(30) Foreign Application Priority Data
Jan. 13, 2014 (TW) 103101147

(51) Int. Cl. G06F 3/0354; G06F 3/038; G06F 3/041

(52) U.S. Cl. CPC G06F 3/03545; G06F 3/0416; G06F 3/0383

(57) ABSTRACT

A stylus without active components includes a housing, and a resonant circuit, such as an LC resonant circuit, disposed in the housing. The resonant circuit is operatively configured to one of a plurality of resonant frequencies respectively associated with a plurality of function modes.

### CROSS-REFERENCE TO RELATED APPLICATIONS

The entire contents of Taiwan Patent Application No. 103101147, filed on Jan. 13, 2014, from which this application claims priority, are incorporated herein by reference.

### BACKGROUND OF THE INVENTION

1. Field of the Invention

The present invention generally relates to a stylus, and more particularly to a stylus without using active components.

2. Description of Related Art

A stylus is an accessory tool that is ordinarily used to assist in navigation when using a touch screen. There are two main types of styluses—active stylus and passive stylus. An active stylus requires, among others, a battery and an integrated circuit (IC) powered by the battery. The active stylus sends radio-frequency (RF) signals (or electromagnetic radiation), which are received by a touch screen and are used to determine specific mode and touch position. Accordingly, the active stylus is commonly heavy and bulky.

On the other hand, a passive stylus retrieves power from RF signals (or electromagnetic radiation) sent from a touch screen. As a result, no battery is thus required. The retrieved power is used to power an integrated circuit (IC), which then controllably sends RF signals to the touch screen.

Either the active stylus or the passive stylus requires, among others, an active electrical component such as an IC for processing and sending signals. The IC, however, consumes substantial power and, more importantly, incurs associated cost.

For the foregoing reasons, a need has arisen to propose a novel stylus and associated touch panel to alleviate power consumption and reduce cost.

### SUMMARY OF THE INVENTION

In view of the foregoing, it is an object of the embodiment of the present invention to provide a stylus without using active components such that stylus architecture may be simplified, and cost and power consumption may be substantially reduced.

According to one embodiment, a stylus without active components includes a housing, and a resonant circuit disposed in the housing. The resonant circuit is operatively configured to one of a plurality of resonant frequencies respectively associated with a plurality of function modes. A touch panel operable with the stylus having no active components includes a plurality of conductive channels, a transmit (Tx) and receive (Rx) unit, an analog front-end (AFE) and a modulator. The Tx and Rx unit is configured to send Tx signals to and then receive Rx signals from the conductive channels in order. The AFE is configured to convert the received RX signal to a digital signal. The modulator is configured to retrieve amplitude and phase of the digital signal.

The Tx signals are sent in a frequency-hopping manner for all the conductive channels through a plurality of resonant frequencies respectively associated with a plurality of function modes of the stylus.

### BRIEF DESCRIPTION OF THE DRAWINGS

FIG. 1A shows a circuit adaptable to and disposed in a stylus according to one embodiment of the present invention;

FIG. 1B shows a schematic diagram illustrating a stylus without using active components;

FIG. 2 shows a schematic diagram illustrating a touch panel operable with the stylus according to one embodiment of the present invention; and

FIG. 3 shows an exemplary timing diagram of sending Tx signals.

### DETAILED DESCRIPTION OF THE INVENTION

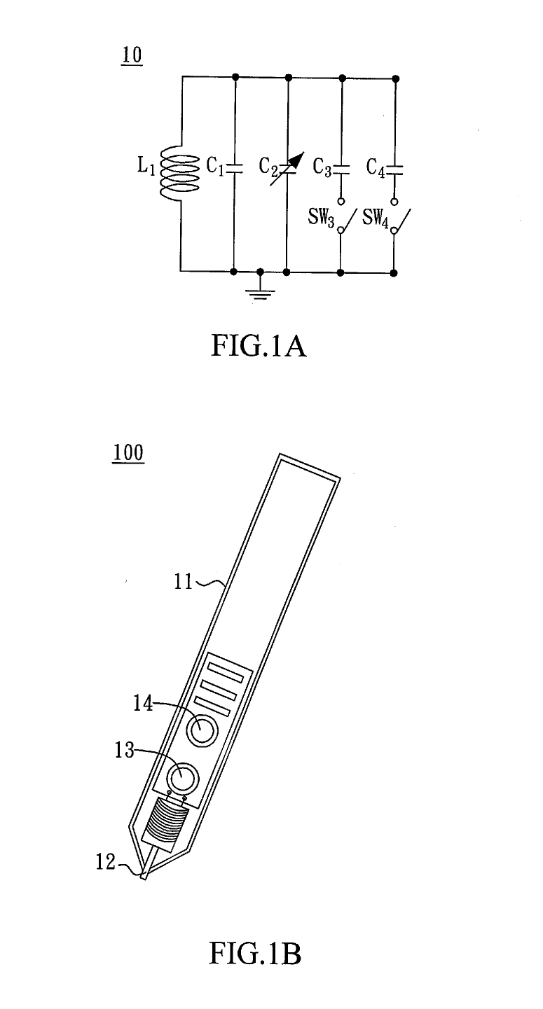

FIG. 1A shows a circuit 10 adaptable to and disposed in a stylus 100, as schematically illustrated in FIG. 1B, without using active components (such as integrated circuits) according to one embodiment of the present invention. In the embodiment, a resonant circuit 10 such as an (inductor-capacitor) LC resonant circuit is disposed in a housing 11 of the stylus 100. The resonant circuit 10 has a resonant frequency, which is varying in the embodiment, at which the resonant circuit 10 is capable of absorbing electromagnetic radiation and then generating signals (of the same resonant frequency) that may then be emitted as electromagnetic radiation.

Specifically, the resonant circuit 10 of the embodiment includes a basis inductor L₁ and a basis (or first) capacitor C₁ that are connected in parallel. The basis inductor L₁ and the basis capacitor C₁ define a basis resonant frequency f_{b}(=½π√ L̅₁̅C̅₁̅), which is decided based on values of L₁ and C₁.

The resonant circuit 10 may further include a variable capacitor C₂, which is connected to the basis inductor L₁ and the basis capacitor C₁ in parallel. The parallel-connected L₁/C₁/C₂ defines a (first) resonant frequency f₁(=½π√ L̅₁̅(̅C̅₁̅+̅C̅₂̅)̅), which is decided based on values of L₁ and (C₁+C₂). Although the basis capacitor C₁ and the variable capacitor C₂ are distinctly depicted in FIG. 1A, it is appreciated that, in practice, the basis capacitor C₁ and the variable capacitor C₂ may be implemented in a single capacitor.

In the embodiment, a value of the variable capacitor C₂ is substantially smaller than a value of the basis capacitor C₁. Accordingly, the parallel-connected L₁/C₁/C₂ may facilitate a pen-tip pressure detection, in which the value of the variable (second) capacitor C₂ varies according to pressure of a pen tip 12 (FIG. 1B). The amount of pen-tip pressure may then be detected by determining a phase of signals emitted from the stylus.

The resonant circuit 10 may further include capacitors (e.g., C₃ and C₄ as shown in FIG. 1A) with fixed values to facilitate more function modes. Two function modes are exemplified in FIG. 1A, while more function modes may be adopted in the stylus. As exemplified in FIG. 1A, the resonant circuit 10 may further include a (third) capacitor C₃, which is connected in parallel to L₁/C₁/C₂ via a (first) switch SW₃. When the switch SW₃ is closed by pushing a button 13 (disposed on the stylus 100) associated, for example, with an erase mode, the parallel-connected L₁/C₁/C₂/C₃ defines a (second) resonant frequency f₂(=½π√ L̅₁̅(̅C̅₁̅+̅C̅₂̅+̅C̅₃̅)̅), which is decided based on values of L₁ and (C₁+C₂+C₃).

Similarly, as exemplified in FIG. 1A, the resonant circuit 10 may further include a (fourth) capacitor C₄, which is connected in parallel to L₁/C₁/C₂ via a (second) switch SW₄. When the switch SW4 is closed by pushing a button 14 (disposed on the stylus 100) associated, for example, with a right-key mode, the parallel-connected L₁/C₁/C₂/C₄ defines a (third) resonant frequency f₃(=½π√ L̅₁̅(̅C̅₁̅+̅C̅₂̅+̅C̅₄̅)̅), which is decided based on values of L₁ and (C₁+C₂+C₄).

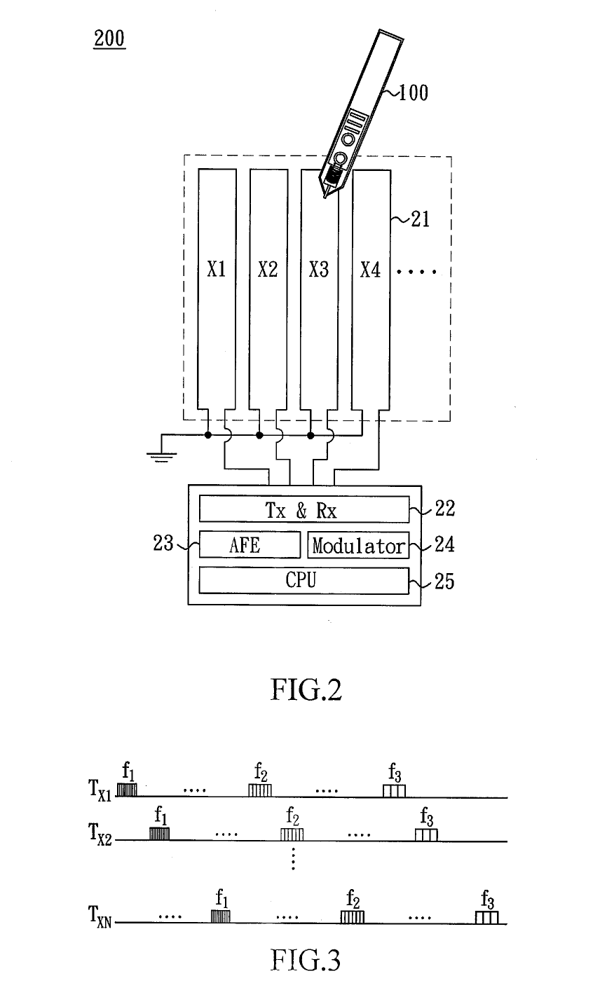

FIG. 2 shows a schematic diagram illustrating a touch panel 200 operable with the stylus 100 according to one embodiment of the present invention. Specifically, the touch panel 200 includes plural conductive channels (or loops) 21 indicated by X1, X2, X3, X4, etc. In operation, a transmit (Tx) and receive (Rx) unit 22 sends a Tx signal to a conductive channel 21, followed by receiving an Rx signal from the same conductive channel 21. The sending Tx and receiving Rx are performed with respect to the conductive channels 21 in sequence (or in a specific order). An analog front-end (AFE) 23 converts the received Rx signal into a digital signal, which is then subjected to a modulator 24 to retrieve associated amplitude and phase of the received Rx signal (i.e., the digital signal). The retrieved amplitude is then processed, for example, by a central processing unit (CPU) 25, to determine a touch position of the stylus 100, and the retrieved phase is then processed, for example, by the CPU 25, to determine pen-tip pressure of the stylus 100.

As there are plural possible resonant frequencies, for example, f₁, f₂ and f₃, as described above, the touch panel 200 may send Tx signals at f₁ for all the conductive channels 21, followed by sending Tx signals at f₂ for all the conductive channels 21, and finally by sending Tx signals at f₃ for all the conductive channels 21. That is, the Tx signals are sent in a frequency-hopping manner. FIG. 3 shows an exemplary timing diagram of sending Txn signals (n=1 to N) for the conductive channels X1 to XN in an order from f₁ to f₃ (or in a specific order).

According to the embodiment described above, as the resonant circuit 10 absorbs only electromagnetic radiation (or Tx signals) corresponding to a specific resonant frequency, a corresponding function mode may thus be detected. With respect to each detected function mode, a touch position of the stylus 100 may be determined by the retrieved amplitude of the received Rx signal as described above.

Although specific embodiments have been illustrated and described, it will be appreciated by those skilled in the art that various modifications may be made without departing from the scope of the present invention, which is intended to be limited solely by the appended claims.

What is claimed is:

1. A stylus without active components, the stylus comprising:
a housing; and
a resonant circuit disposed in the housing, the resonant circuit being operatively configured to one of a plurality of resonant frequencies respectively associated with a plurality of function modes.

2. The stylus of claim 1, wherein the plurality of function modes comprise a pen-tip pressure detection mode, an erase mode and a right-key mode.

3. The stylus of claim 1, wherein the resonant circuit configured with the associated function mode absorbs a transmit (Tx) signal from a touch panel, and then emits a receive (Rx) signal to the touch panel, thereby the touch panel detecting the associated function mode of the stylus according to the Rx signal.

4. The stylus of claim 1, wherein the resonant circuit comprises an LC resonant circuit.

5. The stylus of claim 4, wherein the LC resonant circuit comprises:
a basis inductor;
a first capacitor; and
a variable second capacitor with a value varying according to pressure of a pen tip, and the value of the variable second capacitor being substantially smaller than a value of the first capacitor;
wherein the basis inductor, the first capacitor and the second capacitor are connected in parallel to result in a first resonant frequency which is decided based on a value of the basis inductor and a sum of values of the first capacitor and the variable second capacitor.

6. The stylus of claim 5, wherein the LC resonant circuit generates and emits a signal with a phase being detected to determine the pressure of the pen tip.

7. The stylus of claim 5, further comprising:
a third capacitor; and
a first switch connected with the third capacitor in series;
wherein the series-connected third capacitor and the first switch are connected in parallel to the basis inductor, the first capacitor and the variable second capacitor, thereby resulting in a second resonant frequency which is decided based on the value of the basis inductor and a sum of values of the first capacitor, the variable second capacitor and the third capacitor, when the first switch is closed.

8. The stylus of claim 7, further comprising:
a fourth capacitor; and
a second switch connected with the fourth capacitor in series;
wherein the series-connected fourth capacitor and the second switch are connected in parallel to the basis inductor, the first capacitor and the variable second capacitor, thereby resulting in a third resonant frequency which is decided based on the value of the basis inductor and a sum of values of the first capacitor, the variable second capacitor and the fourth capacitor, when the second switch is closed.

9. A touch panel operable with a stylus having no active components, the touch panel comprising:
a plurality of conductive channels;
a transmit (Tx) and receive (Rx) unit configured to send Tx signals to and then receive Rx signals from the conductive channels in order;
an analog front-end (AFE) configured to convert the received RX signal to a digital signal; and
a modulator configured to retrieve amplitude and phase of the digital signal;
wherein the Tx signals are sent in a frequency-hopping manner for all the conductive channels through a plurality of resonant frequencies respectively associated with a plurality of function modes of the stylus.

10. The touch panel of claim 9, further comprising:
a central processing unit (CPU) configured to process the amplitude of the digital signal to determine a touch position of the stylus, and to process the phase of the digital signal to determine pen-tip pressure of the stylus.

11. The touch panel of claim 9, wherein the plurality of function modes comprise a pen-tip pressure detection mode, an erase mode and a right-key mode.
